(19) United States
(12) Patent Application Publication
(10) Pub. No.: US 2025/0360492 A1
(43) Pub. Date: Nov. 27, 2025

(54) PHOTOCATALYST INCLUDING TiO2-x SELF-DOPED WITH Ti3+ AND METHOD FOR DECOMPOSING NO USING THE SAME

(71) Applicant: KOREA INSTITUTE OF ENERGY TECHNOLOGY, Naju-si (KR)

(72) Inventors: Wonyong CHOI, Seoul (KR); Zhao Shen, Naju-si (KR)

(21) Appl. No.: 19/185,252

(22) Filed: Apr. 22, 2025

(30) Foreign Application Priority Data
May 27, 2024 (KR) 10-2024-0068286

(51) Int. Cl. B01J 21/06; B01J 35/39; B01J 35/64; B01J 37/04; B01J 37/08; C01B 13/02; C01B 21/02

(52) U.S. Cl. CPC B01J 21/063; B01J 35/39; B01J 35/64; B01J 37/04; B01J 37/08; C01B 13/0203; C01B 21/02

(57) ABSTRACT

Provided are a photocatalyst for a NO decomposition reaction and a method for decomposing NO using the same. The photocatalyst includes TiO₂₋ₓ self-doped with Ti³⁺, in which the TiO₂₋ₓ has a Ti³⁺/Ti⁴⁺ ratio of more than 0.18 and 0.05 or less. In addition, the method for decomposing NO using the photocatalyst includes: combining the photocatalyst and NO; irradiating the photocatalyst combined with NO with light; and forming N₂ and O₂. Most preferably, the decomposition method may effectively decompose NO, in particular, low-concentration NO into N₂ and O₂ under room temperature and normal pressure conditions without a reducing agent.

### CROSS-REFERENCE TO RELATED APPLICATIONS

This application claims priority under 35 U.S.C. § 119 to Korean Patent Application No. 10-2024-0068286, filed on May 27, 2024, in the Korean Intellectual Property Office, the disclosure of which is incorporated herein by reference in its entirety.

### TECHNICAL FIELD

The following disclosure relates to a photocatalyst including TiO₂₋ₓ self-doped with Ti³⁺ and a method for decomposing NO using the same.

### BACKGROUND

As air pollution due to nitrogen oxides (NOx) including diesel engine exhaust fumes and the like becomes increasingly serious, various research and technology development for solving global environmental pollution problems are being carried out. In particular, efforts to remove nitric oxide (NO), which accounts for about 95% of emitted nitrogen oxides, are ongoing. Technologies, such as removing NO mainly through an adsorbent, or decomposing NO into harmless materials such as nitrogen, water, and oxygen and discharging them, are being studied.

As an example, there is a selective catalytic reduction (SCR) method. However, the selective catalytic reduction method requires addition of a chemical reducing agent such as H₂ and NH₃ and a high temperature of 200° C. or higher as an essential condition, in order to convert high-concentration NO at a level of hundreds of ppm into N₂. Thus, the selective catalytic reduction method has limitations in substantial use due to the conditions, and most of all, it is not easy to remove low-concentration NO at a level of tens of ppm to ppb in indoor environments and general urban environments.

As another example, an adsorption method may remove low-concentration NO without a reducing agent under a relatively low temperature condition, but a heterogeneous reaction of NO may occur. That is, secondary pollutants such as N₂O and NO₂ are produced from the heterogeneous reaction, which may rather cause environmental pollution. As such, since there is a difficulty in removing NO in indoor or urban environments when only using conventional technology, research and development for effective and easy NO removal are needed.

### SUMMARY

An embodiment of the present disclosure is directed to providing a photocatalyst for a NO decomposition reaction including TiO₂₋ₓ self-doped with Ti³⁺.

Another embodiment of the present disclosure is directed to providing the TiO₂₋ₓ and a method for preparing TiO₂₋ₓ.

Another embodiment of the present disclosure is directed to providing a method for decomposing NO in which NO is decomposed into N₂ and O₂ using the photocatalyst.

Another embodiment of the present disclosure is directed to providing a method for decomposing NO in which NO is decomposed into N₂ and O₂ even under a condition without a reducing agent, a room temperature condition, or a normal pressure condition.

Still another embodiment of the present disclosure is directed to providing a system for air purification to which the method for decomposing NO is applied.

In one general aspect, a photocatalyst for a NO decomposition reaction includes TiO₂₋ₓ self-doped with Ti³⁺, wherein the TiO₂₋ₓ has a Ti³⁺/Ti⁴⁺ ratio of more than 0.18 and 0.50 or less.

In an exemplary embodiment, TiO₂₋ₓ may include oxygen vacancies. In an exemplary embodiment, the TiO₂₋ₓ may have an O_{V}/O_{L} ratio of more than 0.45 and 0.70 or less.

In an exemplary embodiment, the TiO₂₋ₓ may have an activity to light having a wavelength of 300 to 800 nm.

In an exemplary embodiment, the TiO₂₋ₓ may be self-doped with Ti³⁺ by an evaporation induced self-assembly method. In an exemplary embodiment, the TiO₂₋ₓ self-doped with Ti³⁺ may be prepared by including: (A) preparing a mixed solution including a titanium precursor, a pore forming agent, and a volatile organic solvent; (B) self-assembling the mixed solution with a porous titanium aggregate self-doped with Ti³⁺ while evaporating the solvent; and (C) firing the aggregate to convert it into mesoporous TiO₂₋ₓ.

In another general aspect, a method for decomposing NO using the photocatalyst according to the present disclosure described above includes: combining the photocatalyst and NO; irradiating the photocatalyst combined with NO with light; and forming N₂ and O₂.

In an exemplary embodiment, in the decomposition method, NO may be decomposed without a reducing agent.

In an exemplary embodiment, in the decomposition method, NO may be decomposed under a temperature condition of 10 to 120° C.

In an exemplary embodiment, in the decomposition method, NO may be decomposed under a pressure condition of 800 to 1600 hPa.

In an exemplary embodiment, in the decomposition method, NO may have a low concentration of 100 ppmv or less.

In an exemplary embodiment, in the decomposition method, the light may correspond to a wavelength of 300 to 800 nm.

In an exemplary embodiment, in the decomposition method, N₂ and O₂ may be decomposed at a mole ratio of 1:0.6 to 1.2.

In still another general aspect, a system for air purification includes the photocatalyst according to the present disclosure described above.

Other features and aspects will be apparent from the following detailed description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a reaction flow chart showing a decomposition process of NO according to the decomposition method of the present disclosure in an exemplary embodiment.

FIG. 2 is a simplified drawing of the preparation method of Example 1 and Comparative Example 2.

FIG. 3 is a simplified drawing of the structure of a NO decomposition reactor designed for evaluating NO resolution.

FIG. 4 is an XPS spectrum in which Ti³⁺/Ti⁴⁺ ratios and O_{V}/O_{L} ratios of Example 1 and Comparative Example 2 are compared.

FIG. 5 is an XPS spectrum in which Ti³⁺/Ti⁴⁺ ratios and O_{V}/O_{L} ratios of Example 1 and Comparative Example 3 are compared.

FIGS. 6A, 6B, 6C and 6D are graphs showing and comparing NO resolutions of Example 1 and Comparative Example 2 under a condition of irradiation with light having a wavelength of 425 nm.

FIGS. 7A and 7B are graphs showing and comparing NO resolutions of Example 1 and Comparative Example 1 under a condition of irradiation with light having a wavelength of 425 nm.

FIGS. 8A and 8B are graphs showing and comparing NO resolutions of Example 1 and Comparative Example 3 under a condition of irradiation with light having a wavelength of 425 nm.

FIGS. 9A, 9B, 9C and 9D are graphs in which NO resolutions of Example 1 and Comparative Examples 4 to 6 are compared under a condition of irradiation with light having a wavelength of 365 nm or 425 nm.

FIG. 10 is an XPS spectrum in which Ti³⁺/Ti⁴⁺ ratios and O_{V}/Or ratios before the decomposition reaction and after repeating 6 cycles of the decomposition reaction are compared.

FIGS. 11A and 11B are graphs in which resolution stabilities before the NO decomposition reaction and after repeating 6 cycles of the decomposition reaction of Example 1 are compared.

### DETAILED DESCRIPTION OF EMBODIMENTS

Hereinafter, the photocatalyst for a NO decomposition reaction of the present disclosure and a method for decomposing NO using the same will be described in detail. However, it is only illustrative and the present disclosure is not limited to the specific embodiments which are illustratively described in the present disclosure.

The terms used in the present disclosure are selected to be as common as possible and are currently widely used while considering the function of the present disclosure, but they may vary depending on the intention of a person skilled in the art, a convention, the emergence of new technology, or the like. The technical and scientific terms used may have, unless otherwise defined, the meaning commonly understood by those with ordinary skill in the art to which the present disclosure pertains.

The terms such as “comprise” or “have” in the present disclosure and the claims mean that there is a characteristic or a constitutional element described in the specification, and as long as it is not particularly limited, a possibility of adding one or more other characteristics or constitutional elements is not excluded.

A singular expression in the present disclosure and the claims includes a plural expression, unless otherwise explicitly specified as singular. In addition, a plural expression includes a singular expression, unless otherwise explicitly specified as plural.

In addition, the numerical range used in the present disclosure includes all values within the range including the lower limit and the upper limit, increments logically derived in a form and span of a defined range, all double limited values, and all possible combinations of the upper limit and the lower limit in the numerical range defined in different forms. Unless otherwise defined in the present disclosure, values which may be outside a numerical range due to experimental error or rounding off of a value are also included in the defined numerical range.

The term of degree “about” and the like used in the present disclosure and the claims are used in the sense of covering an allowable error when the allowable error exists.

The photocatalyst for a NO decomposition reaction according to an exemplary embodiment of the present disclosure includes TiO₂₋ₓ self-doped with Ti³⁺, in which the TiO₂₋ₓ may have a Ti³⁺/Ti⁴⁺ ratio of more than 0.18 and 0.50 or less. The visible light photocatalyst may include TiO₂₋ₓ self-doped with Ti³⁺ or be formed of the TiO₂₋ₓ. The TiO₂₋ₓ may be an empirical formula expressed from x which is a real number of more than 0 and less than 0.50. This means that the TiO₂₋ₓ includes both Ti³⁺ and Ti⁴⁺ in different chemical states which may correspond to chemical formulae of Ti₂O₃ and TiO₂ simultaneously, means that the larger the x value, the more the self-doped Ti³⁺ sites, and means that the smaller the x value, the less the self-doped Ti³⁺ sites. Specifically, the x value derived from the Ti³⁺/Ti⁴⁺ ratio may be specifically a real number in a range of 0.05 to 0.2, 0.06 to 0.18, or 0.07 to 0.17. Since Ti³⁺ has 3d¹ electrons in the outermost shell, it has a stronger activity than Ti⁴⁺, and thus, the activity of the photocatalyst may be excellent when it includes more Ti³⁺ sites.

Specifically, the Ti³⁺/Tilt ratio may be more than 0.18, 0.19 or more, 0.20 or more, 0.27 or more and 0.50 or less, 0.40 or less, or 0.35 or less, or a value between the numerical ranges.

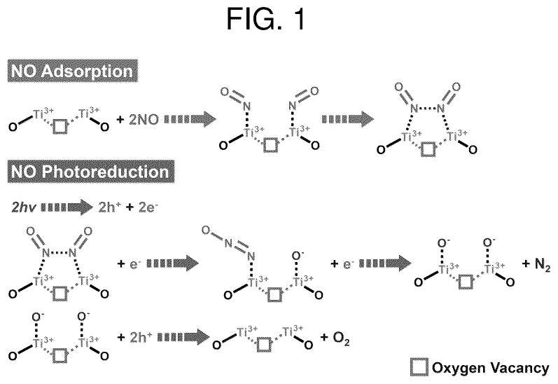

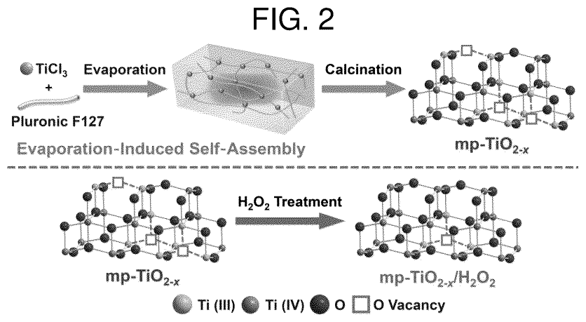

In the case of TiO₂ having only a Ti⁴⁺ site or TiO₂₋ₓ having a Ti³⁺ site corresponding to a ratio of 0.18 or less, due to a low activity of a Ti⁴⁺ site or an insufficient catalytic activity shown by Ti³⁺, the catalytic intermediate as shown in FIG. 1 is not formed well in the NO decomposition reaction and low resolution may be shown.

However, when the TiO₂₋ₓ shows a higher Ti³⁺/Ti⁴⁺ ratio of more than 0.18, preferably 0.27 or more, the catalytic intermediate is not formed well due to a strong activity of Ti³⁺, and thus, excellent resolution may be shown in terms of a NO removal rate, N₂ selectivity, stability, and the like. In addition, when NO and Ti³⁺ are bonded to form a catalytic intermediate, the catalyst having Ti³⁺ having a ratio of more than 0.50 does not have insufficient oxygen vacancies which contribute to Ti³⁺ action, so that additional formation of the catalytic intermediate may not occur any more. Thus, since the catalytic resolution is not increased any more, it may not be preferred.

In addition, the Ti³⁺ acts as a binding site of an NO molecule due to its strong activity and may play an important role in decomposing NO into N₂ and O₂. Specifically, Ti³⁺ may activate the bonded NO molecule and induce an N—N interaction between adjacent NO molecules to form N₂. In addition, the Ti³⁺ may promote hole (valence band hole) carrier separation from light energy of light and contribute to forming O₂ from remaining O⁻ from an NO molecule bound to the hole carrier.

The Ti³⁺/Ti⁴⁺ ratio may be calculated from a ratio between a subarea value of the peak shown by Ti³⁺ and a subarea value of the peak shown by Ti⁴⁺ in a binding energy range of 430 to 490 eV in a spectrum by X-ray photoelectron spectroscopy (XPS). As a specific example, it may be calculated from a ratio between subarea values of 457.9 eV (2p_{3/2}) and 463.6 eV (2p_{1/2}) corresponding to a Ti³⁺ peak and subarea values of 458.7 eV (2p_{3/2}) and 464.5 eV (2p_{1/2}) corresponding to a Ti⁴⁺ peak, in an XPS spectrum measured under the conditions of an X-ray source energy (hv) of 1486.6 eV and an electron work function (Φ) of 4.30 eV.

The TiO₂₋ₓ self-doped with Ti³⁺ may include oxygen vacancies. The oxygen vacancies may contribute to binding of a Ti³⁺ site to NO to perform a decomposition reaction, and as the Ti³⁺ site increases, the oxygen vacancies may also increase. In addition, the oxygen vacancies may be maintained by a hole carrier so that remaining oxygen atoms from NO are not filled.

In an exemplary embodiment, the TiO₂₋ₓ may have an O_{V}/Or ratio of more than 0.45 and 0.70 or less. The O_{V} refers to surface oxygen vacancies, and O_{L} refers to surface lattice oxygen. Specifically, the O_{V}/O_{L} ratio may be more than 0.45, 0.47 or more, 0.50 or more, 0.59 or more and 0.70 or less, or 0.65 or less, or a value between the numerical ranges.

In the case of TiO₂₋ₓ having no oxygen vacancy or oxygen vacancies corresponding to a ratio of 0.45 or less, Ti³⁺ acts as shown in FIG. 1, oxygen vacancies contributing to the process performing the NO decomposition reaction are not sufficient, and thus, low resolution may be shown.

However, when the TiO₂₋ₓ shows a higher O_{V}/O_{L} ratio of more than 0.45, preferably 0.59 or more, action of Ti³⁺ having a strong activity and formation of a catalytic intermediate are promoted from contribution of oxygen vacancies, and thus, excellent resolution may be shown in terms of a NO removal rate, N₂ selectivity, stability, and the like.

In addition, when NO and Ti³⁺ are bonded to form a catalytic intermediate in the NO decomposition reaction, the catalytic having oxygen vacancies having a ratio of more than 0.70 has insufficient Ti³⁺ sites, so that additional formation of the catalytic intermediate may not occur any more. That is, no further decomposition reaction is promoted only by an increase in oxygen vacancies, which may thus, not be preferred.

The O_{V}/O_{L} ratio may be calculated from a ratio between a subarea value of the peak shown by O_{V} and a subarea value of the peak shown by O_{L} in a binding energy range of 510 to 550 eV in a spectrum by X-ray photoelectron spectroscopy (XPS). As a specific example, it may be calculated from a ratio between a subarea value of 529.9 eV corresponding to the O_{L} peak and a subarea value of 530.6 eV corresponding to the O_{V} peak, in an XPS spectrum measured under the conditions of an X-ray source energy (hv) of 1486.6 eV and an electron work function (Φ) of 4.30 eV.

In an exemplary embodiment, the TiO₂₋ₓ has an optical activity and may have an activity to light having a wavelength of 300 to 800 nm. Specifically, it may show an activity to light having a wavelength value of 300 nm to 800 nm, 300 to 700 nm, 300 to 600 nm, 300 to 500 nm, 300 to 450 nm, 300 to 400 nm, 350 to 800 nm, 350 to 700 nm, 350 to 600 nm, 350 to 500 nm, 350 to 450 nm, or a value between the numerical ranges. That is, TiO₂₋ₓ may have an activity to light in the visible light region as described above, and the photocatalyst for a NO decomposition reaction including TiO₂₋ₓ may be a visible light-sensitive photocatalyst. The TiO₂₋ₓ may have the highest activity to light having a wavelength of 300 to 450 nm, 300 to 400 nm, or 350 to 400 nm.

In an exemplary embodiment, the TiO₂₋ₓ may have a porous structure having pores of a mesoporous unit. The average diameter of the pores may be 0.1 nm or more and 10 nm or less, specifically the average diameter may be 10 nm or less, 5 nm or less, 3 nm or less, 1 nm or less and 0.1 nm or more, 0.3 nm or more, or 0.5 nm or more, or a value between the numerical ranges. Preferably, when the average diameter is 0.1 nm or more or 0.5 nm or more, the surface area is large, and reactivity may be better. However, the activity of TiO₂₋ₓ is first determined depending on the Ti³⁺ ratio, and the pores and the surface area may contribute to assisting this.

In addition, the TiO₂₋ₓ may be a mixed phase of an anatase phase and a rutile phase. By mixing the anatase phase and the rutile phase, the photocatalyst may have an increased photoactivity as compared with general TiO₂.

In an exemplary embodiment, the TiO₂₋ₓ may be self-doped with Ti³⁺ by an evaporation induced self-assembly method.

Hereinafter, as an exemplary embodiment, a method for preparing TiO₂₋ₓ self-doped with Ti³⁺ will be described in detail. The TiO₂₋ₓ self-doped with Ti³⁺ may be prepared by including: (A) preparing a mixed solution including a titanium precursor, a pore forming agent, and a volatile organic solvent; (B) self-assembling the mixed solution with a porous titanium aggregate self-doped with Ti³⁺ while evaporating the solvent; and (C) firing the aggregate to convert it into mesoporous TiO₂₋ₓ.

In order to self-dope Ti³⁺ by the evaporation induced self-assembly method, as an example, the titanium precursor may be any one or more selected from titanium salts such as titanium chloride (III) and titanium sulfate (III).

In addition, the pore forming agent may be a block copolymer including one type or more of block structural units selected from the group consisting of polystyrene, polyethylene oxide, polypropylene oxide, polymethylmethacrylate, and polyisoprene. The pore forming agent may be, as an example, a block copolymer such as Pluronic F127, F108, F98, F88, P123, P105, P104, and the like.

In an exemplary embodiment, the mixed solution may include the pore forming agent at a mole ratio of 0.001 to 0.1 with respect to 1 mol of the titanium precursor. Specifically, the pore forming agent may be included at a mole ratio of 0.001 to 0.8, 0.001 to 0.5, 0.001 to 0.03, 0.001 to 0.02, 0.001 to 0.1, 0.005 to 0.1, 0.01 to 0.1, 0.01 to 0.08, or 0.01 to 0.05, or at a mole ratio between the numerical ranges. Preferably, the mole ratio may be 0.005 to 0.02, or 0.01. By including the pore forming agent as such, the prepared TiO₂₋ₓ has a porous structure, has increased surface area and pore volume, and also, forms more Ti³⁺ sites on the surface to promote adsorption and decomposition of NO.

In addition, the volatile organic solvent may be any one or more selected from the group consisting of alcohol-based solvents such as ethanol, chloroform, tetrahydrofuran, and acetylacetone. By using the volatile organic solvent, the solvent evaporates to perform an evaporation induced self-assembly process of self-assembling the titanium aggregate.

In an exemplary embodiment, the mixed solution may form the titanium aggregate in a gel form by evaporating the solvent, and the evaporation may be performed under heating conditions. As an example, the volatile organic solvent may be heated to a temperature at or above an evaporation point to promote evaporation.

In an exemplary embodiment, the firing may be performed under the temperature condition of 400 to 800° C. Specifically, it may be performed under the temperature conditions of 400 to 800° C., 400 to 700° C., 500 to 800° C., 500 to 700° C., or a temperature between the numerical ranges.

When preparing TiO₂₋ₓ as in the preparation method described above, the ratio of self-doped Ti³⁺ is increased, which may be preferred. However, as long as TiO₂₋ₓ may be prepared by self-doping Ti³⁺ so that the physical properties of the present disclosure are satisfied and the Ti³⁺/Ti⁴⁺ ratio is more than 0.18, the method is not necessarily limited only to the above preparation method.

Hereinafter, a method for decomposing NO using the photocatalyst for a NO decomposition reaction described above will be described. As another exemplary embodiment of the present disclosure, the method for decomposing NO uses the photocatalyst for a NO decomposition reaction and includes: combining the photocatalyst and NO; irradiating the photocatalyst combined with NO with light; and forming N₂ and O₂.

In a selective catalytic reduction (SCR) method as a conventional method for decomposing NO, since NO is decomposed at a high temperature of 200° C. or higher and under the condition of adding a reducing agent, the reaction conditions were inefficient and not easy. In addition, in an adsorption method, the NO decomposition reaction may be performed under a relatively low temperature condition, but a large amount of secondary pollutants such as N₂O and NO₂ are produced due to the heterogeneous reaction of NO. As such, there are many limitations in decomposing NO, in particular, low-concentration NO by the conventional method for decomposing NO.

Thus, the present inventors confirmed that NO, in particular, low-concentration NO may be effectively decomposed into N₂ and O₂ by irradiation with light, by using the photocatalyst including TiO₂₋ₓ self-doped with Ti³⁺ described above in the NO decomposition reaction, and derived the method for decomposing NO of the present disclosure. This is a novel method for decomposing NO which has not been confirmed from the conventional photocatalyst of TiO₂ and TiO₂₋ₓ, and may be performed under easier reaction conditions than before and minimize production of N₂O and NO₂. Specifically, NO may be decomposed from the photocatalyst including TiO₂₋ₓ under a condition without a reducing agent, a room temperature condition, or a normal pressure condition, and most preferably, low-concentration NO may be decomposed into N₂ and O₂ under room temperature and normal pressure conditions without a reducing agent.

In an exemplary embodiment, the method for decomposing NO of the present disclosure may be decomposing NO without a reducing agent. As described above, since the photocatalyst according to the present disclosure shows an excellent activity by including TiO₂₋ₓ, it may decompose NO into N₂ and O₂ without a separate reducing agent, unlike conventional reactions. In particular, when low-concentration NO is decomposed, the resolution is the best, and a high NO removal rate, high N₂ selectivity, and high stability may be shown.

In addition, in an exemplary embodiment, NO may be decomposed under the temperature condition of 10 to 120° C. Specifically, the decomposition may be performed under the temperature condition of 10 to 120° C., 20 to 120° C., 30 to 120° C., 10 to 100° C., 10 to 80° C., 10 to 70° C., 10 to 60° C., 10 to 50° C., 10 to 40° C., 10 to 30° C., 20 to 100° C., 20 to 80° C., 20 to 60° C., 20 to 50° C., 30 to 100° C., 30 to 80° C., 30 to 60° C., 30 to 50° C., 10 to 20° C., 15 to 35° C., 10 to 30° C., 15 to 30° C., or between the numerical values in the range. The condition where the decomposition reaction is most easily performed may be a room temperature condition. The room temperature conditions may be, as an example, 15 to 25° C., but may be higher or lower depending on the environment.

In addition, in an exemplary embodiment, the NO may be decomposed under the pressure condition of 800 to 1600 hPa. Specifically, the decomposition may be performed under the pressure condition of 800 to 1600 hPa, 900 to 1600 hPa, 900 to 1400 hPa, 900 to 1300 hPa, 900 to 1200 hPa, 900 to 1100 hPa, 1000 to 1600 hPa, 1000 to 1500 hPa, 1000 to 1400 hPa, 1000 to 1300 hPa, 1000 to 1200 hPa, 1000 to 1100 hPa, 1100 to 1600 hPa, 1200 to 1600 hPa, 950 to 1100 hPa, 950 to 1050 hpa, 1000 to 1050 hPa, or between the numerical values in the range. The condition where the decomposition reaction is most easily performed may be a normal pressure, that is, atmospheric pressure condition. The normal pressure condition may be 1 atm, that is, 1013.25 hPa, but may be higher or lower depending on the position and the environment.

The decomposition method according to the present disclosure may decompose NO into N₂ and O₂ under easier reaction conditions rather than the conventional high temperature condition of 200° C. or higher or the conventional high pressure condition, and as the easiest reaction conditions, even under room temperature and normal pressure conditions. In particular, when low-concentration NO is decomposed under the room temperature and normal pressure conditions, the above decomposition method may show the best resolution.

In an exemplary embodiment, NO may have a low concentration of 100 ppmv or less. Specifically, the concentration may be 100 ppmv or less, 90 ppmv or less, 80 ppmv or less, 70 ppmv or less, 60 ppmv or less, 50 ppmv or less, 40 ppmv or less, 30 ppmv or less, 20 ppmv or less, 10 ppmv or less, 5 ppmv or less, 1 ppmv or less, or a concentration in the numerical ranges, or less. Most preferably, NO may have a low concentration of 10 ppmv or less, 5 ppmv or less, or 1 ppmv or less. The decomposition method of the present disclosure may decompose NO into N₂ and O₂ effectively, under the easy reaction conditions unlike the conventional technology, at 100 ppmv or less, as described above.

In an exemplary embodiment, light used for irradiation in the decomposition method corresponds to a wavelength of 300 to 800 nm. This means that the light may have the same or similar wavelength region where TiO₂₋ₓ of the present disclosure described above shows an optical activity and may be light in the visible light region. In addition, when light having a wavelength of 300 to 450 nm, 300 to 400 nm, or 350 to 400 nm where TiO₂₋ₓ has the highest activity is used for irradiation, the decomposition method may show the highest NO resolution.

In an exemplary embodiment, the combining of the photocatalyst and NO in the decomposition method may be combining NO in a Ti³⁺ site of TiO₂₋ₓ included in the photocatalyst to form an intermediate. The intermediate may be in the form of N₂O₂-catalyst intermediate where the catalyst and a NO molecule are combined, and as an example, may be in the form in which each of two NO molecules is bonded to Ti³⁺ at one site.

In addition, light energy used for irradiation in the irradiating of the photocatalyst combined with NO with light may be separated into an electron (e⁻) and a hole carrier (h⁺) from Ti³⁺.

The electron may reduce a N₂O₂-catalyst intermediate to form a N₂₀-catalyst intermediate form, and further reduce the N₂₀-catalyst intermediate to finally form N₂. Herein, the intermediate may break a N═O bond and reconstruct a N═N bond due to the strong activity of Ti³⁺ to form N₂. The hole carrier may form O₂ from a remaining O-atom bonded to Ti³⁺.

As such, NO may form N₂ and O₂ using the photocatalyst including TiO₂₋ₓ self-doped with Ti³⁺ according to the present disclosure, and in an example, the decomposition process of NO according to the present decomposition method may be expressed as the reaction flow chart shown in FIG. 1.

In FIG. 1, specifically, the TiO₂₋ₓ included in the photocatalyst adsorbs a NO molecule in the Ti³⁺ site and may form a N₂O₂ intermediate where a N—N interaction between adjacent NO molecules is induced. In addition, the N₂O₂ intermediate is reduced from an electron (e⁻) of irradiated light to form a N₂O intermediate, and the N₂O intermediate may be reduced to form N₂. Since Ti³⁺ has an outermost electron of 3d¹, it shows a strong activity, and thus, it may break a N═O bond and reconstruct a N═N bond to form N₂. Thereafter, a remaining 0-atom bonded to Ti³⁺ may be converted into O₂ from the hole carrier (h⁺) of the irradiated light.

In an exemplary embodiment, the N₂ and O₂ formed by decomposing NO by the decomposition method may be decomposed at a mole ratio of 1:0.6 to 1.2. Specifically, the mole ratio may be 1:0.6 to 1.2, 1:0.6 to 1.1, 1:0.6 to 1.0, 1:0.6 to 0.9, 1:0.7 to 1.2, 1:0.8 to 1.2, 1:0.9 to 1.2, 1:0.8 to 1.1, or a value between the numerical ranges. Preferably, the N₂ and O₂ may be decomposed at a very uniform mole ratio of 1:0.9 to 1.1. The decomposition method means that N₂ and O₂ may be uniformly formed at the mole ratio, by using the photocatalyst including TiO₂₋ₓ self-doped with Ti³⁺, and may minimize formation of N₂O and NO₂ due to a heterogeneous reaction.

In an exemplary embodiment, the decomposition method may show a NO removal rate of 60% or more. That is, the NO removal rate is a NO decomposition rate and may mean that NO corresponding to 60% or more of an initial NO concentration may be decomposed according to the decomposition method of the present disclosure. By using the photocatalyst including TiO₂₋ₓ self-doped with Ti³⁺, the decomposition method of the present disclosure may decompose 70% or more or 80% or more of NO on low-concentration NO.

In addition, in an exemplary embodiment, the decomposition method may have a N₂ selectivity of 50% or more. The N₂ selectivity refers to a characteristic of N₂ formation without producing other N₂O₂, NO₂, and the like by a side reaction in the NO decomposition reaction and may be calculated by the following Equation 2. By using the photocatalyst including TiO₂₋ₓ self-doped with Ti³⁺, the decomposition method of the present disclosure may show 60% or more, 70% or more, 80% or more, most preferably 90% or more N₂ selectivity on low-concentration NO.

In an exemplary embodiment, the NO decomposition method may show the highest resolution when it is performed under an inert gas atmosphere including no O₂, but when it is performed under a gas atmosphere including O₂, a high N₂ selectivity of 50% or more may be shown. The O₂ may be preferably included at 10 vol % or less or 5 vol % or less.

In an exemplary embodiment, the NO decomposition method may maintain excellent resolution showing a NO removal rate of 60% or more even under the relative humidity condition of 0 to 100%. As the relative humidity is lower, the removal rate of NO may be further increased, and most preferably, a NO removal rate of 80% or more may be shown under the relative humidity condition of 0%.

In an exemplary embodiment, TiO₂₋ₓ included in the photocatalyst in the NO decomposition method may maintain the Ti³⁺/Ti⁴⁺ ratio and the O_{V}/O_{L} ratio before and after the NO decomposition. That is, since the physical properties of TiO₂₋ₓ are not changed even with the repeated NO decomposition reactions, the photocatalyst may have excellent stability, and may maintain excellent resolution such as a NO removal rate and N₂ selectivity in the decomposition reaction.

It is difficult to apply the conventional method for decomposing NO to indoor environment conditions due to the limitations in reaction conditions and resolution, but in another exemplary embodiment of the present disclosure, the method for decomposing NO described above may be applied to a system for air purification. According to the decomposition method of the present disclosure, since NO may be effectively decomposed into N₂ and O₂ under visible light even under normal pressure and room temperature conditions without a reducing agent, it may be preferred that the photocatalyst is applied to a system for air purification which decomposes low-concentration NO produced in indoor and urban environments.

Hereinafter, the examples of the present invention will be further described with reference to the specific experimental examples. It is apparent to those skilled in the art that the examples and the comparative examples included in the experimental examples only illustrate the present invention and do not limit the appended claims, and various modifications and alterations of the examples may be made within the range of the scope and spirit of the present invention, and these modifications and alterations will fall within the appended claims.

### [Example 1] mp-TiO₂₋ₓ

mp-TiO₂₋ₓ was prepared by adding 4.00 mmol of an aqueous TiCl₃ solution to a solution in which 0.02 mmol of Pluronic F127 was mixed with 1.00 mL of ethanol. The mixture was heated and stirred in order to promote solvent evaporation to prepare it in a gel form, which was transferred to a crucible, heated at a rate of 5° C./min, and fired at 600° C. for 3 hours. After the firing, it was sufficiently cooled down to complete preparation of mp-TiO₂-x powder.

### [Comparative Example 1] bulk-TiO₂₋ₓ

bulk-TiO₂₋ₓ was prepared in the same manner as in Example 1, except that Pluronic F127 was not included.

### [Comparative Example 2] mp-TiO₂₋ₓ/H₂O₂

In order to see the change in a Ti³⁺/Ti⁴⁺ ratio, H₂O₂ was artificially used to oxidize Ti³⁺ so that the Ti³⁺/Ti⁴⁺ ratio was decreased to 0.18 or less. Specifically, 0.32 g of mp-TiO₂₋ₓ powder prepared in Example 1 was dispersed in 4.10 ml of a 30 wt % H₂O₂ solution, and stirring was performed at 100° C. for 8 hours to oxidize some of Ti³⁺. Thereafter, water was evaporated to prepare mp-TiO₂₋ₓ/H₂O₂.

### [Comparative Example 3] mp-TiO₂₋ₓ/NaBH₄

In order to see the change in a Ti³⁺/Ti⁴⁺ ratio, NaBH₄ was artificially used to increase Ti³⁺ sites so that the Ti³⁺/Ti⁴⁺ ratio was increased to more than 0.50. Specifically, a mixture obtained by crushing and mixing 0.64 g of the mp-TiO₂₋ₓ prepared in Example 1 and 0.46 g (12.00 mmol) of NaBH₄ was transferred to a crucible and fired at 350° C. for 1 hour at a heating rate of 5° C./min. After cooling to room temperature, washing with ethanol and water was performed to remove residues, and drying was performed at 80° C. for 6 hours to prepare mp-TiO₂₋ₓ/NaBH₄ having increased Ti³⁺ sites.

### [Comparative Example 4] P25

Degussa P25 (TiO₂) available from Tokyo Chemical Industry (TCI) was purchased and used as Comparative Example 4.

### [Comparative Example 5] g-C₃N₄

g-C₃N₄ available from Tokyo Chemical Industry (TCI) was purchased and used as Comparative Example 5.

### [Comparative Example 6] WO₃

WO₃ available from Tokyo Chemical Industry (TCI) was purchased and used as Comparative Example 6.

### [Evaluation Method]

1. Ti³⁺/Ti⁴⁺ Ratio and O_{V}/O_{L} Ratio

Analysis of Ti³⁺/Ti⁴⁺ and O_{V}/Or ratios was performed using K-alpha XPS equipment available from Thermo Scientific which uses non-monochromatic Al-Kα as an X-ray source, and the electron work function (Φ) at this time was 4.30 eV.

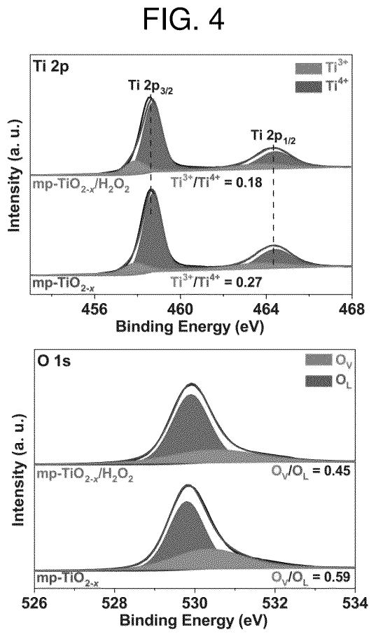

In the measured XPS spectrum, the Ti³⁺/Ti⁴⁺ and O_{V}/O_{L} ratios were calculated from subarea values of each peak intensity, in 457.9 eV (2p_{3/2}) and 463.6 eV (2p_{1/2}) corresponding to a Ti³⁺ peak, 458.7 eV (2p_{3/2}) and 464.5 eV (2p_{1/2}) corresponding to a Ti⁴⁺ peak, 529.9 eV corresponding to an Or peak, and 530.6 eV corresponding to an O_{V} peak. The results are shown in FIGS. 4, 5, and 10.

### 2. NO Resolution

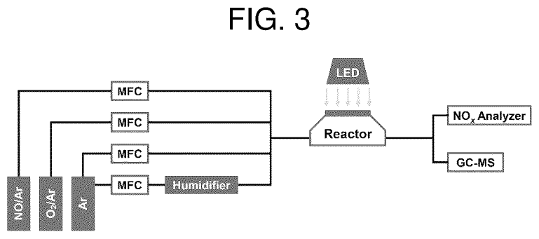

In order to evaluate NO resolution, a NO decomposition reactor was schematically designed as shown in FIG. 3.

Specifically, a quartz glass chamber was installed in a closed circulation glass reactor having a capacity of 300 ml equipped with a quartz window having a radius of 3 cm, and 0.15 g of the photocatalysts of the example and the comparative examples were dispersed in 2 cm×2 cm sized grooves in the quartz glass chamber. An LED lamp was used as a light source, and light irradiated from the LED lamp showed intensities of 18, 23, 32, and 50 mW/cm² at wavelengths of 365 nm, 385 nm, 405 nm, and 425 nm, respectively, when measured using a 1918-R power meter available from Newport.

In addition, the reaction was performed at 25° C. under room temperature and normal pressure conditions of 1 atm in the decomposition reactor, NO having a concentration of 2.0 ppmv and Ar were mixed and continuously added to the decomposition reactor, and a residence time of NO was maintained at 30 min.

The concentrations of NO and NO₂ were measured using NOx analyzer 17i available from Thermo Scientific, and the concentrations of N₂O, N₂, and O₂ were GC-MS analyzed using 7890A-5975B available from Agilent. Additionally, in order to confirm the contents of NO₂⁻, NO₃⁻, and the like adsorbed in the photocatalyst after the reaction, suspension obtained by dispersing the photocatalyst in water, stirring it, and filtering the solution was analyzed by ion chromatography with Dionex ICS-900 available from Thermo Scientific, but they were not detected.

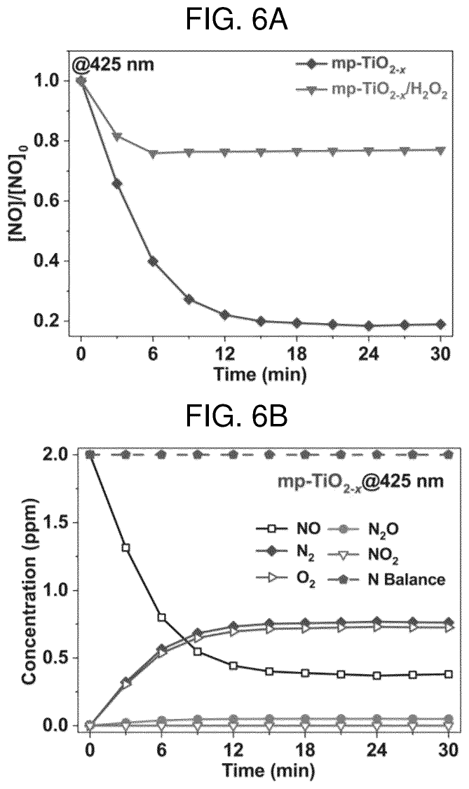

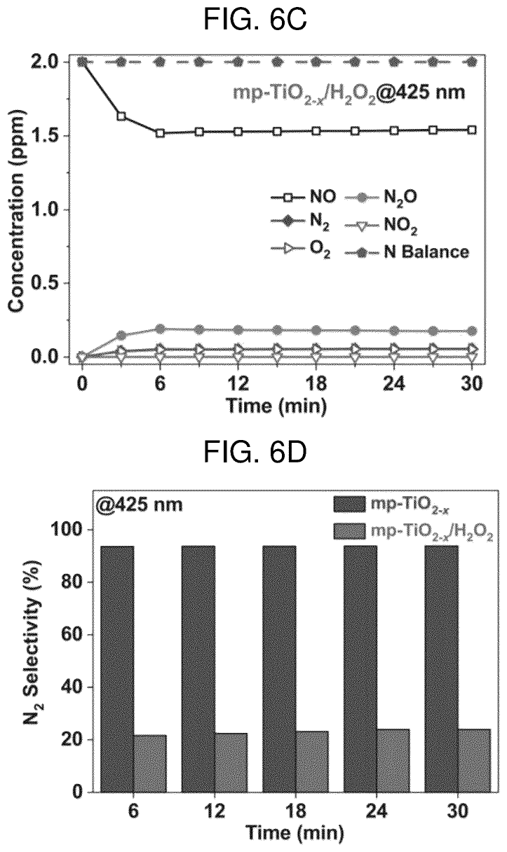

In the result graph, [NO]/[NO]₀ and N₂ selectivity were calculated from the concentrations of the reactant and the product which were introduced to and discharged from the reactor as shown in the following Equations 1 and 2. The results of analyzing the NO resolution as such are shown in FIGS. 6A to 9D.

$$[ NO ] {/ [ NO ]}_{0} = \frac{( {[ NO ]}_{i n} - {[ NO ]}_{out} )}{{[ NO ]}_{i n}} \qquad [ Equation 1 ]$$

$${N}_{2} selectivity = \frac{{2 [ {N}_{2} ]}_{out}}{( {2 [ {N}_{2} ]}_{out} + {2 [ {N}_{2} O ]}_{out} + {[ {NO}_{2} ]}_{out} )} \times 100 \% \qquad [ Equation 2 ]$$

### 3. Catalytic Stability

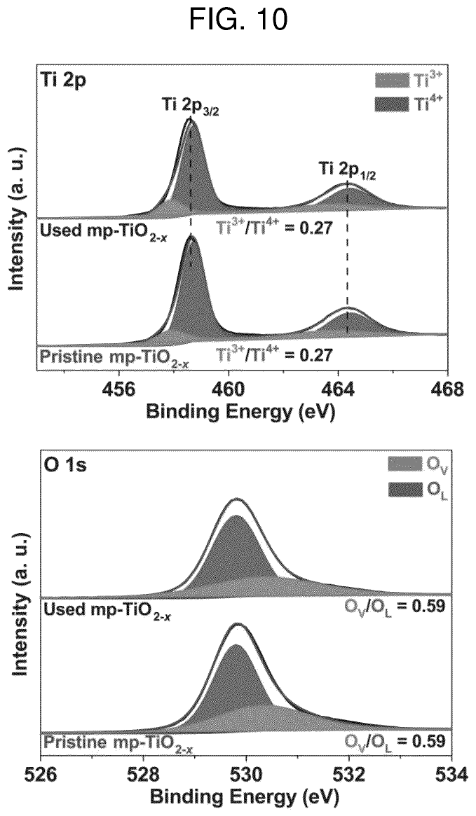

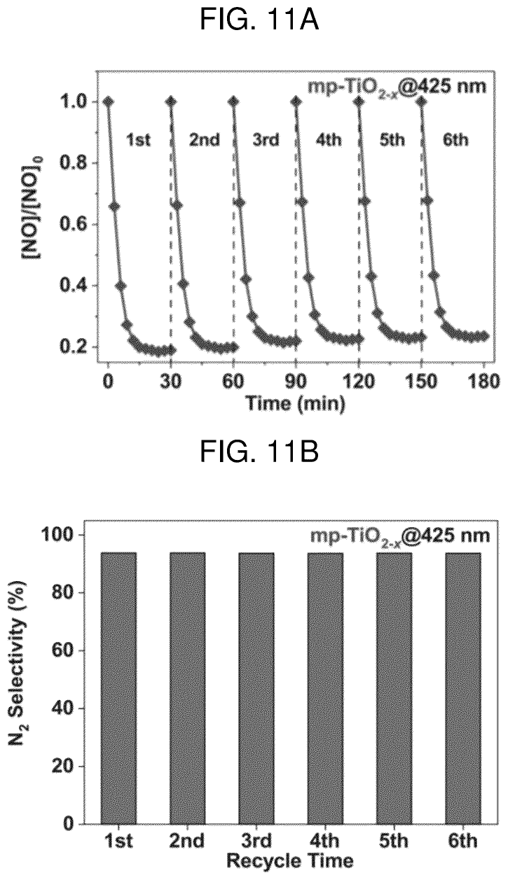

The decomposition reaction was repeated for 6 cycles in the NO decomposition reactor described above under the condition of irradiation with light having a wavelength of 425 nm. Thereafter, the XPS analysis and NO resolution analysis were performed to evaluate the change and stability of the photocatalyst depending on the repeated performance. The results are shown in FIGS. 10, 11A and 11B.

Hereinafter, the results of evaluating the example and the comparative examples according to the evaluation methods described above will be described.

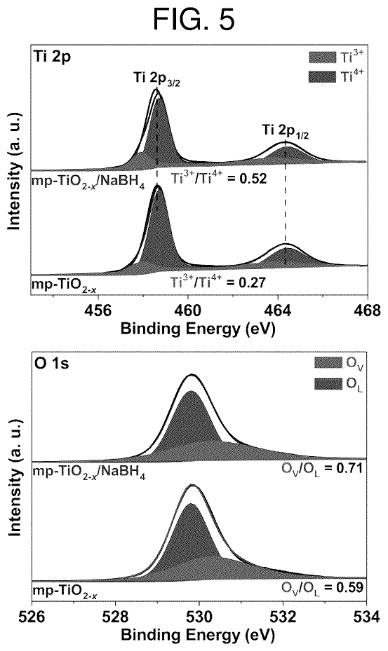

First, in FIGS. 4 and 5, an XPS spectrum in which Ti³⁺/Ti⁴⁺ ratios and O_{V}/O_{L} ratios of Example 1 and Comparative Example 3 were compared was confirmed. As a result, Example 1 showed the Ti³⁺/Ti⁴⁺ ratio of 0.27 and the O_{V}/O_{L} ratio of 0.59. However, in FIG. 4, Comparative Example 2 showed the Ti³⁺/Ti⁴⁺ ratio of 0.18 and the O_{V}/O_{L} ratio of 0.45. It was confirmed from the results that since Example 1 had more Ti³⁺ sites than Comparative Example 2 to satisfy the value of the Ti³⁺/Ti⁴⁺ ratio of more than 0.18 and 0.50 or less and had more O_{V} sites than Comparative Example 2 to satisfy the value of the O_{V}/Or ratio of more than 0.45 and 0.70 or less. In addition, in FIG. 5, since Comparative Example 3 had increased Ti³⁺ sites, it showed the Ti³⁺/Ti⁴⁺ ratio of 0.52 exceeding 0.50 and the O_{V}/O_{L} ratio of 0.71 exceeding 0.70. For reference, though not shown in the drawing, the Ti³⁺/Ti⁴⁺ ratio was 0.09 and the O_{V}/O_{L} ratio was 0.13 in Comparative Example 1.

Next, graphs in which NO resolution was evaluated were confirmed in FIGS. 6A to 9D.

FIGS. 6A, 6B, 6C and 6D are graphs in which the NO resolutions of Example 1 and Comparative Example 2 were compared under the condition of irradiation with light having a wavelength of 425 nm, in which FIG. 6A confirms [NO]/[NO]₀, and FIG. 6B and FIG. 6C are graphs of the measured concentrations of the products depending on the NO decomposition reactions of Example 1 and Comparative Example 2, respectively, and confirmed the product from the NO decomposition reaction and the concentration thereof. FIG. 6D is a graph showing N₂ selectivity.

As a result, in FIGS. 6A, 6B, 6C and 6D, Example 1 showed significantly better NO removal rate and Na selectivity than Comparative Example 2, and decomposed NO uniformly into N₂ and O₂ without producing N₂O and NO₂. Specifically, in FIG. 6A, Example 1 showed the [NO]/[NO]₀ value of about 0.2 showing that about 80% or more of introduced NO was removed, that is, decomposed, but Comparative Example 2 showed the [NO]/[NO]₀ value of about 0.75 showing that only about 25% of the introduced NO was removed. In addition, in FIG. 6B, Example 1 decomposed 20 ppmv of NO to form N₂ and O₂ reaching about 0.75 ppmv without formation of N₂O and NO₂, but in FIG. 6C, Comparative Example 2 formed almost no N₂ and O₂ and formed rather only about 0.25 ppmv of N₂₀. In FIG. 6D also, Example 1 showed the N₂ selectivity of about 94% showing that most of NO was decomposed and converted into N₂ without formation of N₂₀ and NO₂, but Comparative Example 2 had the N₂ selectivity of only about 24% showing that a large amount of by-products other than N₂ were formed.

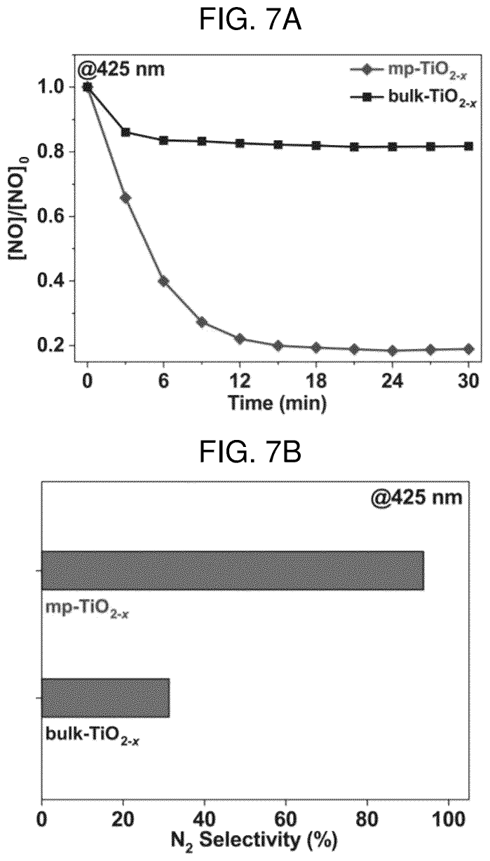

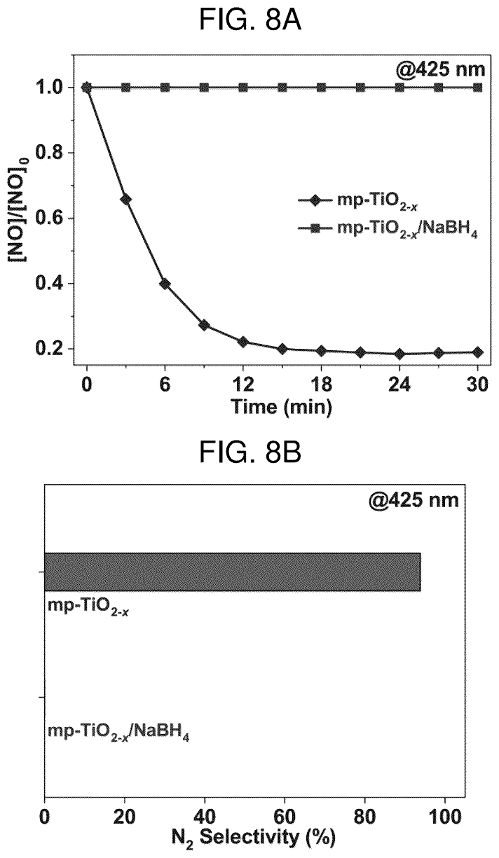

In addition, FIGS. 7A, 7B, 8A and 8B are graphs in which the NO resolutions of Example 1, Comparative Example 1, and Comparative Example 3 were compared under the condition of irradiation with light having a wavelength of 425 nm, in which FIG. 7A and FIG. 8A confirmed [NO]/[NO]₀, and FIG. 7B and FIG. 8B are graphs showing N₂ selectivity.

As a result, in FIGS. 7A, 7B, 8A and 8B, the resulting values of Example 1 were the same as the resulting values of FIGS. 6A, 6B, 6C and 6D, and in FIGS. 7A and 7B, and it was found that Comparative Example 1 showed the [NO]/[NO]₀ value of about 0.85 showing that only about 15% of NO was removed, and had the N₂ selectivity of only about 33% showing that a large amount of by-products other than N₂ were formed. In addition, it was confirmed that Comparative Example 3 of FIGS. 8A and 8B removed almost no introduced NO and the catalytic activity was almost insignificant.

It was found therefrom that even though the Ti³⁺ sites were increased to show a high value, the catalytic activity was not good, and it was confirmed that Example 1, which satisfied the value of the Ti³⁺/Ti⁴⁺ ratio of more than 0.18 and 0.50 or less and the value of the O_{V}/Or ratio of more than 0.45 and 0.70 or less, showed significantly better NO removal rate and N₂ selectivity than Comparative Examples 1 and 3.

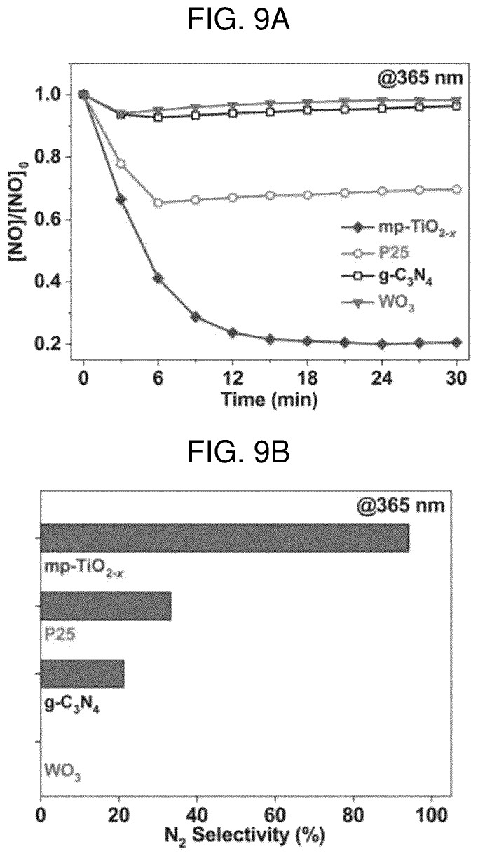

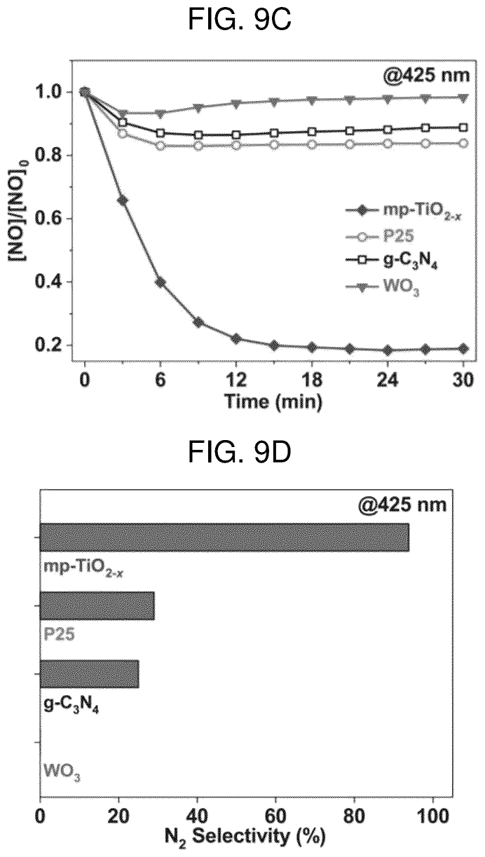

In addition, FIGS. 9A, 9B, 9C and 9D are graphs in which the NO resolutions of Example 1 and Comparative Examples 4 to 6 which are conventionally used as the catalysts for a NO decomposition reaction were compared under the condition of irradiation with light having wavelengths of 365 nm (FIG. 9A and FIG. 9B) or 425 nm (FIG. 9C and FIG. 9D), in which [NO]/[NO]₀ may be confirmed in FIG. 9A and FIG. 9C, and FIG. 9B and FIG. 9D are graphs showing the N₂ selectivity.

As a result, in FIGS. 9A, 9B, 9C and 9D, the resulting value of Example 1 was the same as the resulting value of FIGS. 6A, 6B, 6C and 6D under the wavelength condition of 425 nm, and the similar resulting value to that under the 425 nm wavelength condition was shown under the 365 nm wavelength condition. Comparative Example 4 showed the [NO]/[NO]₀ value of up to about 0.65 or about 0.8 in FIG. 9A and FIG. 9C, which was the highest among the comparative examples, so that about 20 to 35% of the introduced NO was removed, but the N₂ selectivity was only about 30% in FIG. 9B and FIG. 9D, showing that a large amount of by-products other than N₂ were formed. Thus, it was confirmed therefrom that Example 1 showed significantly better NO removal rate and N₂ selectivity than Comparative Examples 4 to 6.

Next, graphs in which stabilities before and after the decomposition reaction of Example 1 were compared were confirmed in FIGS. 10, 11A and 11B. As a result, it was confirmed that in Example 1, the physical properties were not changed before and after the decomposition reaction and excellent NO resolution was maintained.

Specifically, FIG. 10 shows results of comparing Ti³⁺/Ti⁴⁺ ratios and O_{V}/O_{L} ratios before the decomposition reaction and after repeating 6 cycles of the decomposition reaction in Example 1 identically through the XPS analysis, and the ratios before and after the decomposition reaction were identical. In addition, FIGS. 11A and 11B are graphs in which the resolution stabilities before the NO decomposition reaction and after repeating 6 cycles of the decomposition reaction in Example 1 are compared, and the [NO]/[NO]₀ value of FIG. 11A and the N₂ selectivity of FIG. 11B were maintained the same with almost no change.

As a result, it was confirmed from the evaluation results that the photocatalyst according to the present disclosure shows an excellent activity in the NO decomposition reaction, by including TiO₂₋ₓ self-doped with Ti³⁺ so that the Ti³⁺/Ti⁴⁺ ratio described above are satisfied. In addition, it was confirmed that the Ti³⁺/Ti⁴⁺ ratio was more than 0.18 and Ti³⁺ was self-doped at a value of 0.50 or less, by preparing TiO₂₋ₓ by the evaporation induced self-assembly method according to the present disclosure.

In addition, as a result of performing the NO decomposition reaction under room temperature and normal pressure conditions without a reducing agent, Comparative Examples 1 to 3 which did not satisfy the Ti³⁺/Ti⁴⁺ ratio and Comparative Examples 4 to 6 corresponding to the conventional catalysts showed low NO removal rate and N₂ selectivity, and showed a significant difference in the NO resolution from the example according to the present disclosure. That is, it was confirmed that the catalyst according to the present disclosure may show excellent NO resolution under easy reaction conditions where a reducing agent, high temperature, and high pressure are not needed unlike the conventional catalyst. In particular, it was confirmed that when the decomposition reaction on low-concentration NO is performed under room temperature and normal pressure conditions without a reducing agent, excellent NO resolution and stability, such as a NO removal rate, high N₂ selectivity, and uniform N₂ and O₂ formation are able to be shown.

According to an exemplary embodiment of the present disclosure, the photocatalyst for a NO decomposition reaction including TiO₂₋ₓ self-doped with Ti³⁺ may show an excellent catalytic activity. Specifically, the TiO₂₋ₓ may show an excellent activity by self-doping with Ti³⁺.

In addition, according to an exemplary embodiment of the present disclosure, the method for decomposing NO using the photocatalyst may decompose NO into N₂ and O₂ without formation of N₂O and NO₂ or with minimal formation of N₂O and NO₂.

In addition, according to an exemplary embodiment of the present disclosure, the method for decomposing NO using the photocatalyst may show excellent resolution even under any one condition selected from a condition without a reducing agent, a room temperature condition, or a normal pressure condition.

In addition, according to an exemplary embodiment, the method for decomposing NO using the photocatalyst may effectively decompose particularly low-temperature NO.

Although the exemplary embodiments of the present disclosure have been described above, the present disclosure is not limited to the exemplary embodiments but may be carried out in various forms different from each other, and those with ordinary skill in the art to which the present disclosure pertains will understand that the present disclosure may be implemented in other specific forms without departing from technical spirits or the essential feature of the present invention. Therefore, it should be understood that the exemplary embodiments described above are not restrictive, but illustrative in all aspects.

What is claimed is:

1. A photocatalyst for a NO decomposition reaction comprising TiO₂₋ₓ self-doped with Ti³⁺, wherein the TiO₂₋ₓ has a Ti³⁺/Ti⁴⁺ ratio of more than 0.18 and 0.50 or less.

2. The photocatalyst for a NO decomposition reaction of claim 1, wherein the TiO₂₋ₓ includes oxygen vacancies.

3. The photocatalyst for a NO decomposition reaction of claim 1, wherein the TiO₂₋ₓ has an O_{V}/O_{L} ratio of more than 0.45 and 0.70 or less, in which O_{V} refers to surface oxygen vacancies and O_{L} refers to surface lattice oxygen.

4. The photocatalyst for a NO decomposition reaction of claim 1, wherein the TiO₂₋ₓ has an activity to light having a wavelength of 300 to 800 nm.

5. The photocatalyst for a NO decomposition reaction of claim 1, wherein the TiO₂₋ₓ is self-doped with Ti³⁺ by an evaporation induced self-assembly method.

6. The photocatalyst for a NO decomposition reaction of claim 5, wherein the TiO₂₋ₓ self-doped with Ti³⁺ is prepared by including:
(A) preparing a mixed solution including a titanium precursor, a pore forming agent, and a volatile organic solvent;
(B) self-assembling the mixed solution with a porous titanium aggregate self-doped with Ti³⁺ while evaporating the solvent; and
(C) firing the aggregate to convert it into mesoporous TiO₂₋ₓ.

7. A method for decomposing NO using the photocatalyst of claim 1, the method comprising:
combining the photocatalyst and NO;
irradiating the photocatalyst combined with NO with light; and
forming N₂ and O₂.

8. The method for decomposing NO of claim 7, wherein the NO is decomposed without a reducing agent.

9. The method for decomposing NO of claim 7, wherein the NO is decomposed under a temperature condition of 10 to 120° C.

10. The method for decomposing NO of claim 7, wherein the NO is decomposed under a pressure condition of 800 to 1600 hPa.

11. The method for decomposing NO of claim 7, wherein the NO has a low concentration of 100 ppmv or less.

12. The method for decomposing NO of claim 7, wherein the light corresponds to a wavelength of 300 to 800 nm.

13. The method for decomposing NO of claim 7, wherein the N₂ and O₂ are decomposed at a mole ratio of 1:0.6 to 1.2.

14. A system for air purification comprising the photocatalyst of claim 1.
